(19) United States
(12) Patent Application Publication
(10) Pub. No.: US 2008/0149581 A1
(43) Pub. Date: Jun. 26, 2008

(54) Upright Protector

(75) Inventors: Murray Clarke, New South Wales (AU); Paul Berry, New South Wales (AU); Stephen Celati, New South Wales (AU)

Correspondence Address: THE WEBB LAW FIRM, P.C., 700 KOPPERS BUILDING, 436 SEVENTH AVENUE, PITTSBURGH, PA, 15219, US

(73) Assignee: DEMATIC PTY LTD, Belrose, NSW (AU)

(21) Appl. No.: 11/665,170

(22) PCT Filed: Oct. 13, 2005
(86) PCT No.: PCT/AU2005/001587

§ 371 Date: Oct. 31, 2007

(30) Foreign Application Priority Data
Oct. 13, 2004 (AU) 2004905942

(51) Int. Cl. A47B 96/00; A47B 95/04; A47B 91/00; F16M 13/00

(52) U.S. Cl. 211/183; 248/519

(57) ABSTRACT

A protector for a structural member includes a body having a front portion and opposite side portions that extend from at least part of the front portion to define a channel. The protector is locatable over the structural member so that at least a portion of that member is received within the channel. In one form, the side portions include an inwardly turned lip that defines a constricted throat of the channel. The protector may also include bearing members which are arranged to clamp onto the front base of the structural member. A two part protector is also disclosed with one part forming a base assembly for the structural member. The protector has particular application in storage racking systems and also disclosed are assemblies for use in the support structure of a storage racking system that incorporates the protector, and associated storage racking systems including such assemblies.

The present invention relates generally to protectors for structural members and to systems that use such protectors. The invention has been developed especially, but not exclusively, for use in protecting uprights in storage racking systems and is herein described in that context. However, it is to be appreciated the invention has broader application and is not limited to that use.

### BACKGROUND

Storage racking systems are widely used in warehousing and other industrial facilities. These systems typically include multiple levels of shelving or beams for cartons or pallets which are supported by vertical load bearing members commonly referred to as uprights. These uprights are typically made from a profiled steel section and metal bracing is provided which extends between adjacent uprights.

The racks are usually arranged in spaced rows with aisles formed between the racks that allow access to the stock. To make the most efficient use of the available space, these aisles are made as narrow as possible. As such, there is an ongoing risk of damage to the racking system, particularly the upright, from handling equipment such as forklifts or the like in view of the confined spaces in which the handling equipment operate. This is particularly problematic as a damaged upright may have significantly reduced load bearing capacity and can be awkward to replace. Accordingly, it is beneficial to use protective measures to maintain the integrity of the racking system.

### SUMMARY

In a first aspect, the invention relates to a protector for a structural member comprising a body having a front portion and opposite side portions extending from at least one part of the front portion to define a channel, the protector being locatable over the structural member so that at least a portion of the member is received within the channel, wherein at least one of the side portions includes an inwardly turned lip that defines a constricted throat of the channel.

In one form, both side portions include an inwardly turned lip.

In one form, the body is formed from sheet metal, preferably sheet steel. In one form, the thickness of the steel is in the order of 3 mm-6 mm.

In a particular form, the protector is designed to be used on a structural member that has an enlarged head portion and a narrower rear portion. In one arrangement, the protector is operative to be located over the member by first being presented at an angle to the member so that one leg locates in the rear portion, whereafter, the protector is rotated so as to locate fully the protector over the member.

This arrangement has the particular advantage of allowing the protector to fit snugly over the structural member as it does not require the opening at the throat of the protector to be as large as the maximum width of the head portion of the member. In this way, the amount of space the protector occupies can be minimised which is important in some applications such as in racking systems where space saving is a major consideration. In addition, by having the inwardly turned lips, the prospects of handling equipment or the like catching an exposed edge of the protector, which could otherwise damage the protector and/or the structural member, is reduced.

In one form, the protector further comprises at least one bearing member that is connected to or integrally formed with the body, and being disposed on an inner side of the front portion so as to be arranged to bear against the structural member.

The purpose of the at least one bearing member is to provide the main contacting surface between the protector and the structural member. In this way, the protector is better able to distribute any force imparted to the structural member from the protector such as may occur if the protector is impacted. Further, the bearing member can be positioned on the protector so that when the protector is installed on an upright, the bearing member is generally aligned with a braced section of the upright so that forces impacted from the protector are transferred to the braced section of the upright.

In a further aspect, the present invention provides a protector for a structural member comprising a body having a front portion and opposite side portions extending from at least one part of the front portion to define a channel, the protector being locatable over the structural member so that at least a portion of the structural member is received within the channel, wherein the protector further comprises at least one bearing member that is connected to, or integrally formed with, the body, and being disposed on an inner side of the front portion so as to be arranged to bear against the structural member.

In one form, the protector comprises a plurality of bearing members which are spaced apart from one another.

In one form, the at least one bearing member is located within the channel so as to form a gap between the bearing member and the front portion of the protector body.

In one form, the at least one bearing member is channel shaped and extends across the front portion of the protector body and across at least part of the opposite side portions. By having the bearing members extend along at least part of the side portion increases the capacity of the protector to accommodate side impact. In particular having a portion of the bearing members extend along the side portion causes the bearing member to act as a spacer between the side portions and the structural member.

In one form, the protector includes at least two outer bearing members and at least one intermediate clamping member disposed between the bearing members.

In one form, the protector is secured to the structural member by fasteners and, in one particular embodiment, these fasteners extend through the clamping member.

In one form, the clamping member is offset from the bearing members in a direction towards the front portion, and wherein on securing the protector to the structural member, the clamping member is drawn into engagement with the structural member.

In this way, on tightening the fasteners, either or both of the protector and the structural member is caused to flex slightly so as to draw the clamping member into engagement with the structural member. With this arrangement, both the outer bearing members are forced into solid contact with the structural member.

In one form, the side portions each extend from one end of the protector to the other so that the channel is continuous along the length of the protector. In another form, the protector is arranged to be fitted to structural members that support beams that extend transversely from the structural member. In that arrangement at least one of the side portions extends along only a part of the front portion to form a recess in the protector. The recess is arranged to accommodate the beam extending transversely from the structural member.

In one form, the channel is formed in a plurality of sections that are separated by opposing recesses formed in respective ones of the side portions.

In one form, at least one recess is disposed adjacent at least one end of the protector.

In a particular embodiment, the protector is connected to a base plate on which the structural member is arranged to locate. In this way the protector forms part of a base assembly of a system (such as a racking system) that incorporates the structural member. In one form, the base plate incorporates apertures to allow fixing of the base plate to an underlying structure.

In yet a further aspect, the invention relates to a protector for a structural member comprising first and second parts, each part having a body extending between opposite ends and having a front portion and opposite side portions that extend from at least one part of the front portion to define a channel, the parts being arranged so that at least a portion of the structural member is able to be received in the respective channels, wherein the first and second parts are arranged in use to be disposed in end to end and overlapping relationship on the structural member.

In one form, the side portions of the first part terminate in board of one end of that part to form a tail region that extends to the one end and is arranged to lap with the second part.

In one form, when the tail region of the first part is lapped with the second part, at least one of the side portions of the first part is spaced from the corresponding side portion of the second part to form a recess arranged to receive a beam that extends transversely from the structural member.

In one form, the tail region includes at least one stiffening member. In the form where the front portion is formed from mutually inclined parts, the stiffening member is arranged to extend across those parts to inhibit splaying of the parts.

In one form, one of the parts of the protector is incorporated in a base assembly on which the structural member is arranged to be located. The base assembly may further comprise an anchoring device arranged to receive at least one mechanical fastener to secure the structural member to that part of the protector. The anchoring device may comprise a fixing plate disposed within the channel and one or more aligned apertures which extend both through the front portion and the fixing plate of that part.

In one form, at least one of the parts includes the features of the constricted throat and/or bearing members of the other aspects of the invention.

In a further aspect, the invention relates to an assembly for use in the support structure of a storage racking system, the assembly comprising an elongated structural member, and a protector according to any form described above, wherein at least a portion of the structural member is receivable in the or each channel of the protector.

In one form, the structural member is a profiled section having an enlarged head and a narrower rear region. In one form, the protector includes the constricted throat described above and wherein the distance between the side portions at the constricted throat is less than the width of the enlarged head region.

In a particular form, the or each inwardly turned lip of the constricted throat of the channel locates in or over the narrower rear region of the structural member.

In one form, where the protector includes at least one bearing member described above, the bearing member is arranged to bear against a front face of the enlarged head region of the structural member.

In yet a further aspect, the invention relates to a storage racking system incorporating a support structure assembly according to any form described above.

### BRIEF DESCRIPTION OF THE DRAWINGS

It is convenient to hereinafter describe an embodiment of the present invention with reference to the accompanying drawings. It is to be appreciated the particularity of the drawings and the related description is to be understood as not superseding the generality of the preceding broad description of the invention.

In the drawings:

FIG. 1 is a front view of a typical racking system;

FIG. 2 is a side view of the racking system of FIG. 1;

FIG. 3 is a front perspective view of an upright protector for use in the racking system of FIG. 1;

FIG. 4 is a rear perspective view of the protector of FIG. 3;

FIG. 5 is a plan view of the protector of FIG. 3;

FIGS. 6a to 6e is an assembly sequence for mounting the protector of FIG. 3 onto an upright of the racking system of FIG. 1;

FIGS. 7a to 7e is an assembly sequence for mounting a variation of the protector of FIG. 3 onto the upright of the racking system of FIG. 1;

FIG. 8 is a front view of a CLS racking system;

FIG. 9 is a side view of the CLS racking system of FIG. 8;

FIG. 10 is a detailed front perspective view of a protector mounted to an upright of the CLS racking system of FIG. 8;

FIG. 11 is a rear perspective view of the protector of FIG. 10;

FIGS. 12a to 12e is as assembly sequence for mounting the protector of FIG. 10 onto an upright of the CLS racking system of FIG. 8;

FIG. 13 is a front view of a low beam racking system;

FIG. 14 is a side view of the low beam racking system of FIG. 13;

FIG. 15 is an exploded front perspective view of the parts of the protector of the low beam racking system of FIG. 14;

FIG. 16 is an exploded rear perspective view of the parts of the protector for the low beam racking system of FIG. 14;

FIG. 17 is a plan view of the upper part of the protector of FIG. 15;

FIG. 18 is a plan view of the base part of the protector of FIG. 15; and

FIGS. 19a to 19h is an assembly sequence for mounting the protector of FIG. 15 onto an upright of the low beam racking system of FIG. 13.

### DETAILED DESCRIPTION OF THE DRAWINGS

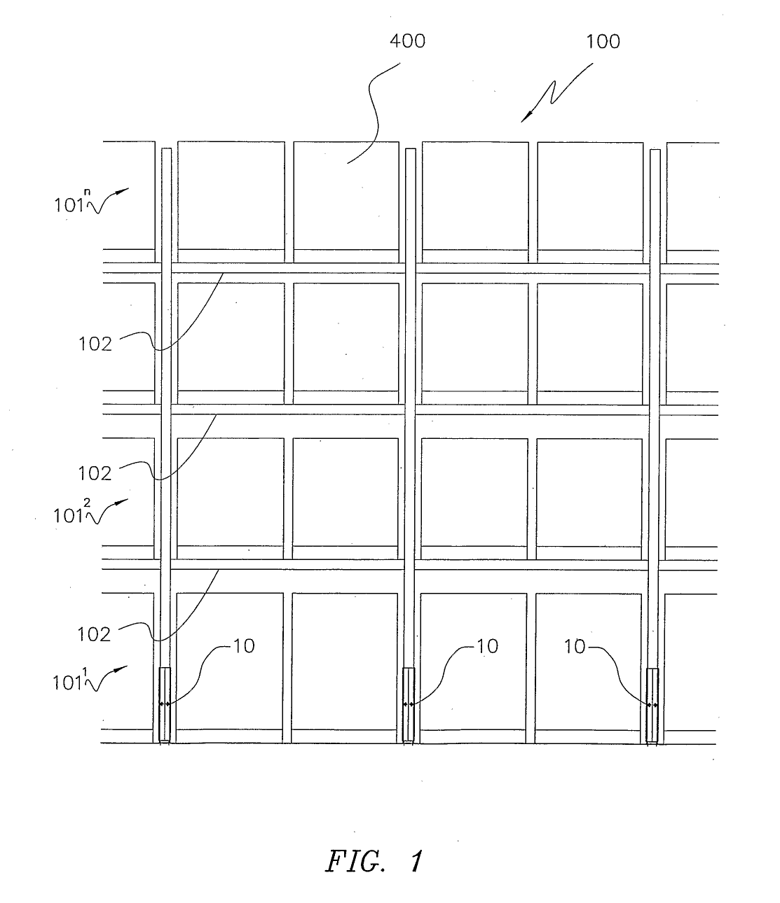

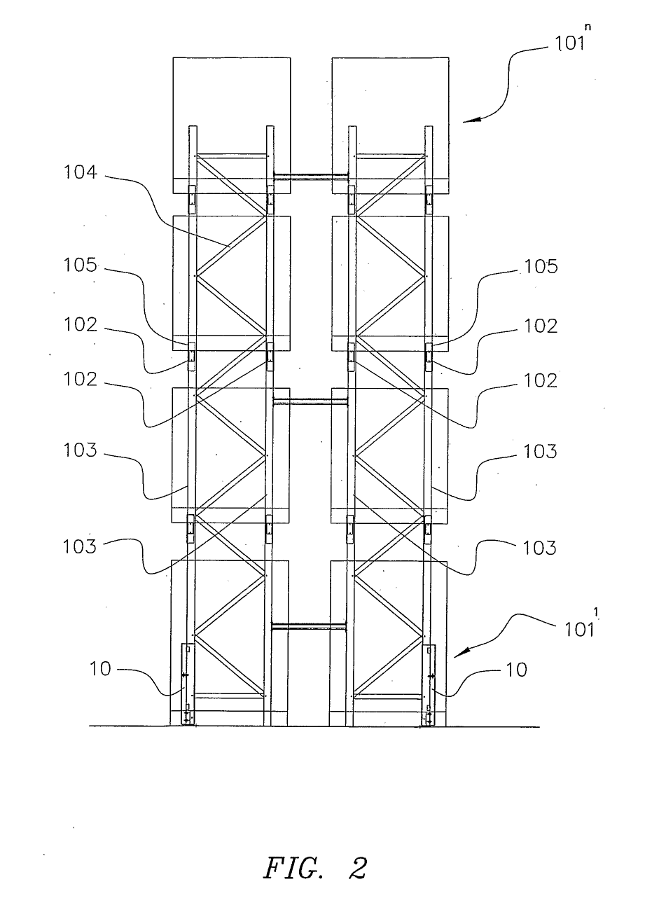

FIGS. 1 and 2 illustrate a typical storage racking system 100 that includes multiple levels (101¹ . . . 101¹¹) of metal racking beams that are supported by vertical members 103 that are commonly referred to as uprights. These uprights are typically made from a profiled steel section and metal bracing 104 is provided which extends between adjacent uprights 103. The metal racking beams 102 include connectors 105 at opposite ends which connect the beams 102 to the adjacent uprights 103.

Pallets 400 incorporating stock thereon are supported on the racking beams 102 at the various levels 101¹ . . . 101ⁿ. These pallets are typically placed and removed from the racking system 100 by handling equipment such as forklifts or the like.

To make the most efficient use of the available space, it is typical that the aisles between the individual racks are as narrow as possible. As such, there is an ongoing risk of damage to the racking system, particularly the uprights 103, from the handling equipment. To protect the uprights therefore, protectors 10 are disposed at the lower end of the individual uprights 103.

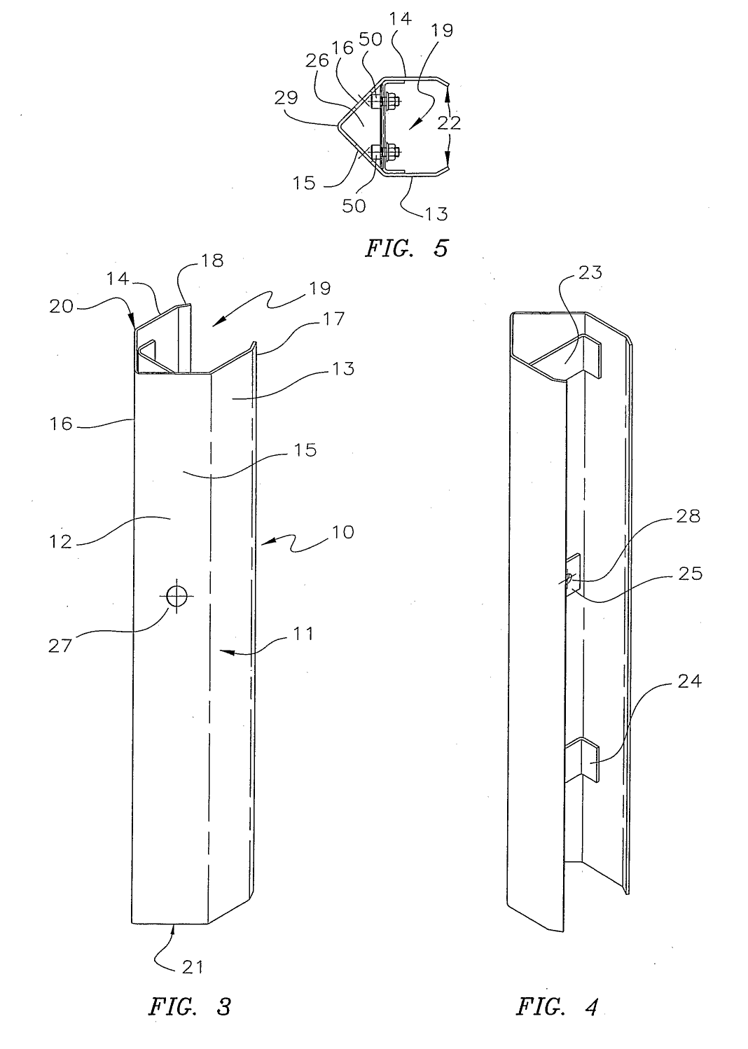

FIGS. 3 to 5 illustrate the protector 10 for use on the upright 103 of the typical racking system 100 shown in FIGS. 1 and 2. The protector 10 includes a body 11 which is typically formed from sheet metal that is profiled to be generally channel shaped having a front portion 12 and opposing side portions 13 and 14. The front portion 12 is formed from mutually inclined portions 15, 16 that taper towards a ridge 29. The side portions 13 and 14 each include an inwardly turned lip (17 and 18 respectively).

The body 11 defines a channel 19 that extends between opposite ends 20 and 21 of the protector 10. The inwardly turned lips 17 and 18 on the sides 13 and 14 define a constricted throat 22 of the channel 19.

The protector 10 further includes a plurality of bearing members (23, 24). These bearing members are disposed within the channel 19 and are mounted to the side portions 13 and 14 so that a gap 26 is formed between the bearing members (23, 24) and the front portion 12.

As will be described in more detail below, the bearing members (23 and 24) are operative to bear against the racking upright 103. The bearing members are generally channel shaped so as to extend both across the channel 19 and also along part of the side portions 13 and 14. In this way, the bearing members act as a spacer between the upright 103 and the protector body 11.

The protector 10 further comprises an intermediate clamping member 25 that is disposed between the bearing members 23 and 24. The clamping member 25 is offset slightly from the bearing members toward the front portion 12. This offset is fairly minor and is typically less than 5 mm.

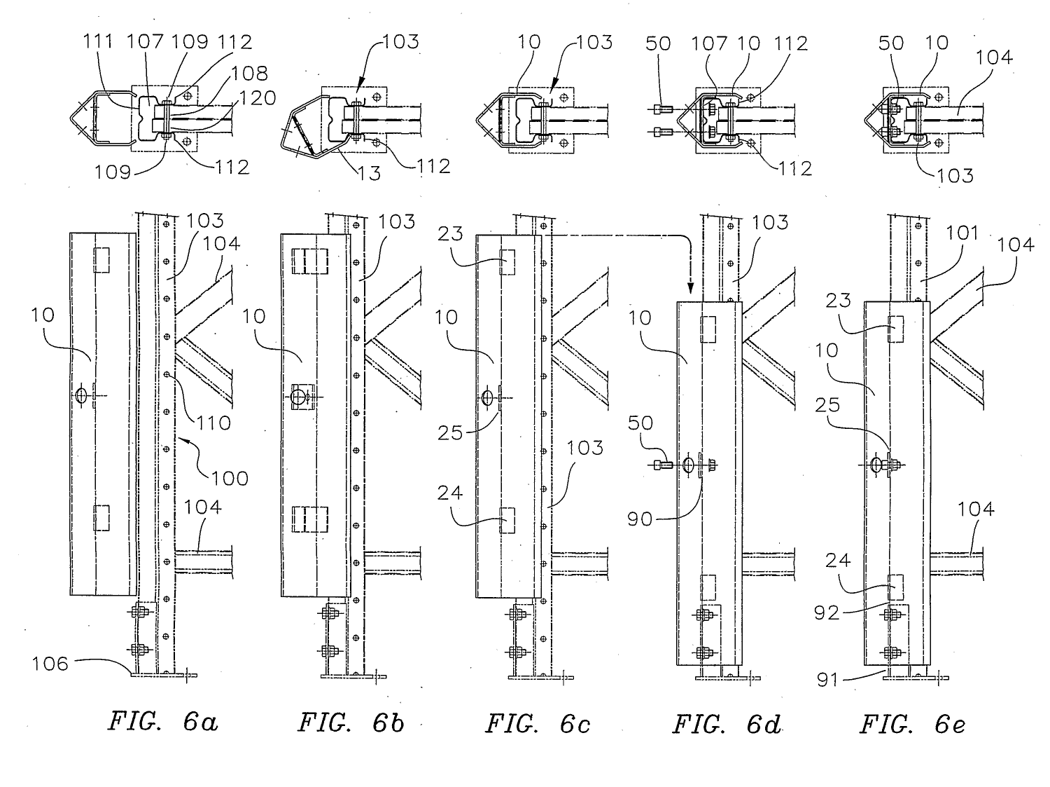

The protector 10 is designed to be fastened to the upright by mechanical fasteners 50 as disclosed in the assembly sequence shown in FIGS. 6a to 6e. To accommodate these fasteners, apertures 27 and 28 are formed in the front portion 12 and through the clamping member 25.

FIGS. 6a to 6e illustrate the sequence involved in mounting the protector 10 onto the upright 103 of the racking system 100. Typically the racking system also includes a rack base plate 106 which supports the uprights 103.

The uprights 103 are formed from a profiled metal section which has a bulbous cross-section incorporating an enlarged head portion 107 and a narrower rear portion 108. This rear portion provides a recess 109 which is adapted to receive fasteners 120 (typically in the form of a nut and bolt arrangement) which is used to secure the bracing 104. In this regard, the upright 103 typically incorporates a plurality of pre-formed apertures 110 that extend along the recess 109.

The front face 111 of the upright 103 also includes two lines of apertures which are disposed in pairs along the upright 103.

As generally seen in FIGS. 6a to 6e, the protector 10 is designed to be mounted adjacent the rack base plate 106. Specifically, the protector 10 in this embodiment is disposed just above the top of the base plate 106 so that the base plate 106 does not foul it when it is being installed.

To mount the protector 10 onto the upright 103, it is presented at an angle to the upright 103 as illustrated in FIG. 6b. In this way, one of the side portions 13 locates within the recess 109. This action is required as the width of the throat 22 is less than the width of the front 111 of the upright 103.

Once the side portion 13 is located within the recess 109 in the upright 103, the protector 10 can then be rotated onto the upright 103 with the other side portion being clear of the head portion 107 of the upright 103. This rotating action then positions the upright as illustrated in FIG. 6c.

The protector 10 can then be moved laterally towards the front 111 of the upright 103 so as to bring the bearing members 23 and 24 into contact with the front 111 of the upright 103. Because of the offset of the intermediate clamping member 25, a gap 90 is maintained between the clamping member 25 and the front 111 of the upright. Once in this position, the protector is then moved down the upright 103 so that it locates over the rack base plate 106 as shown in FIG. 6d.

The protector 10 is located over the base plate and is positioned so that the apertures 27 and 28 align with one of the pairs of apertures (not shown) located in the front 111 of the upright 103. When in this position, a clearance gap 91 is provided between the bottom 21 of the protector and the bottom of the base plate 106, and a gap 92 is provided between the lower bearing member 24 and an upper end of the base plate 106. Also, the bearing members 23 and 24 align substantially with the bracing 104.

Fasteners 50 in the form of retaining bolts are located through the apertures 27 and 28 and are tightened so as fix the protector 10 to the upright 101. In doing so, the clearance gap 90 between the clamping plate 25 and the front 111 of the upright is closed so as to clamp fully the protector to the upright 103. This action ensures that there is good contact between each of the bearing members 23 and 24 and the upright 103.

Once secured in position, the protector 10 provides a barrier that will inhibit damage of the upright 101 under impact loading. Specifically, any impact applied to the front portion of the protector does not translate a concentrated force to the upright but rather distributes the force over the two bearing members 23 and 24, which in turn transfer the force through their nearby bracing 104. In addition, the protector sits snugly over the upright 103 thereby providing a low profile and as such does not impinge substantially into the surrounding space. In addition, by having the lips 17 and 18 of the side portions 13 and 14 extend inwardly reduces the prospect of the edges being caught which could otherwise damage the protector or the upright.

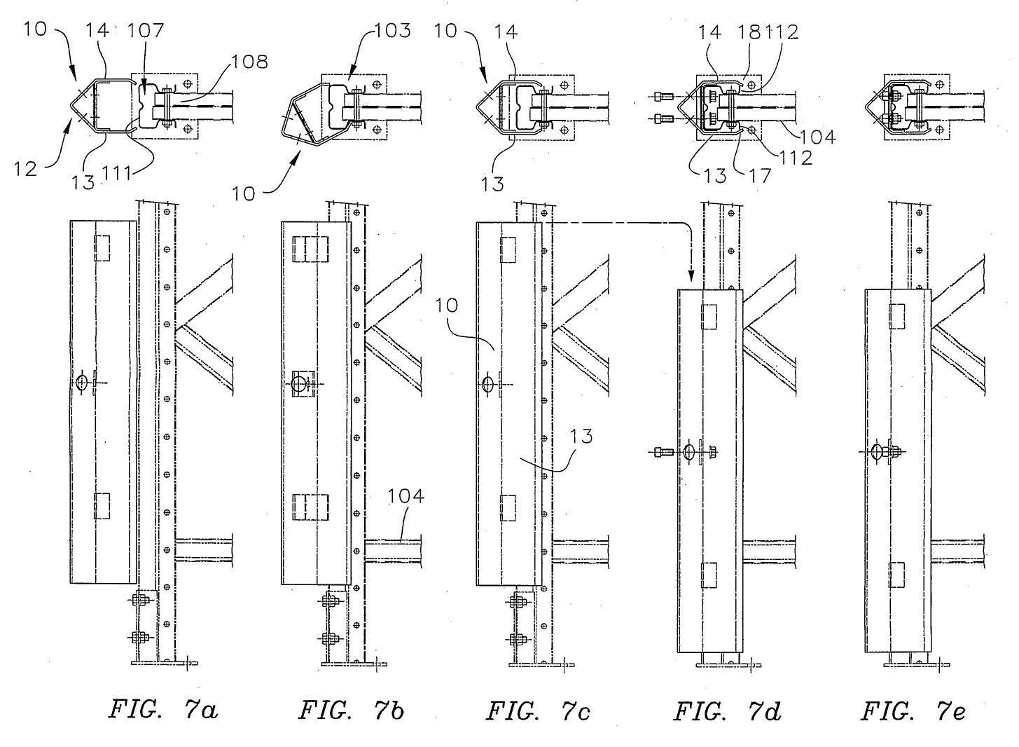

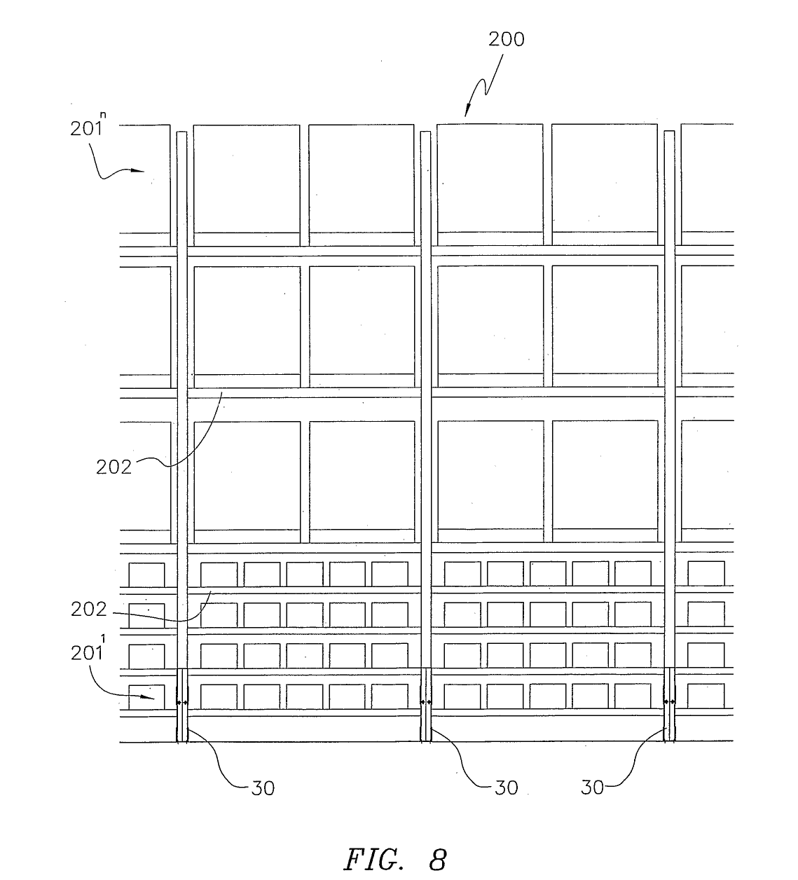

FIGS. 7a to 7e illustrate the sequence involved in mounting a variation of the protector 10 onto the upright 103 of the racking system 100. The protector shown in FIGS. 7a to 7e is the same as the protector shown in the earlier figures with the exception that the side portions 13, 14 are slightly longer so that the inwardly turned lips 17 and 18 locate around the entire upright 103 as best illustrated in FIGS. 7d and 7e. In the earlier embodiment shown in FIGS. 6a to 6e, the side portions 13 and 14 of the protector terminated just short of the rear flanges 112 of the upright 103.

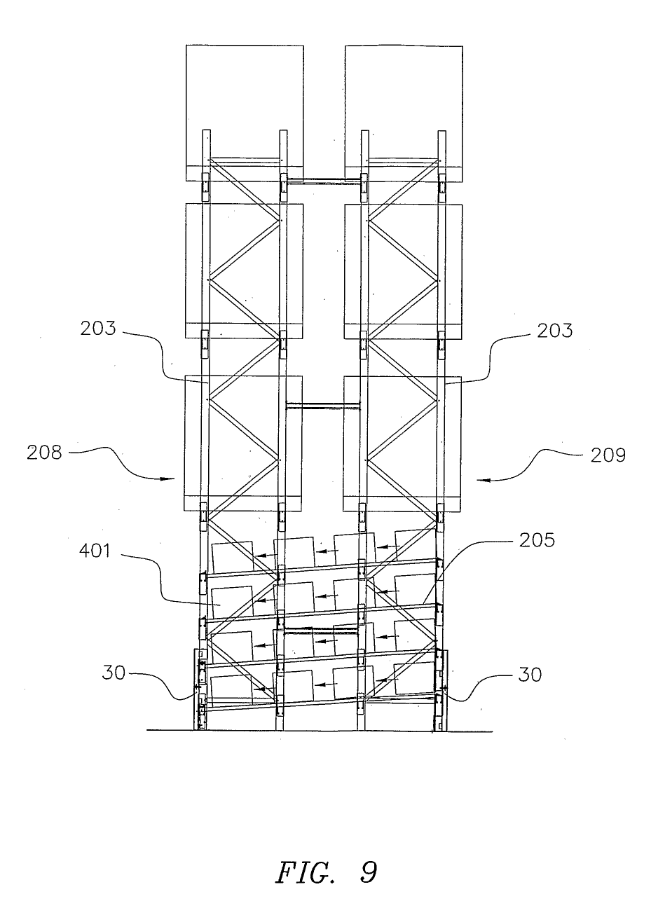

FIGS. 8 to 9 illustrate a different type of storage racking system 100 commonly referred to as a carton live storage (CLS) racking system 200. The CLS system again includes multiple levels 201¹ to 201ⁿ of metal racking beams 202 that are supported by uprights 203. Again these uprights which are made from a profiled steel section are supported by metal bracing 204 which extends between adjacent uprights 203.

The main difference between the CLS racking system and the typical racking system of FIGS. 1 and 2 is that the CLS racking system includes a series of closely spaced racking beams at its lower end which are designed to receive cartons 401 to allow manual stock picking in the warehouse. To facilitate the manual stock picking these lower beams 202 are at different heights so that support shelving 205 located on the beams are inclined towards the front of the CLS racking system.

In an arrangement similar to the earlier embodiment, the CLS racking system 200 also includes protectors 30 which are designed to locate over the lower end of the uprights 203. In the illustrated form protectors are formed on both the front 208 and the rear 209 of the racking system 200.

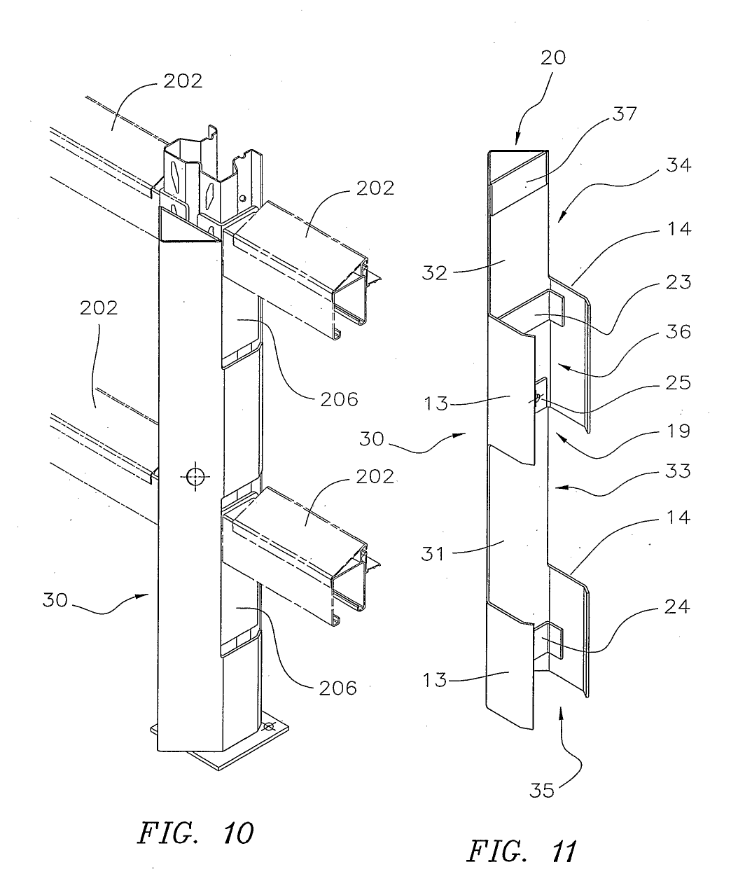

FIGS. 10 and 11 illustrate the protector 30 in more detail. The protector 30 shown is designed to be used at the rear 209 of the CLS racking system 200 and includes many of the features of the protector 10 of the earlier racking system 100. For convenience, like features have been given like reference numerals.

The main distinguishing feature of the CLS protector 30 over the protector 10 is that the side portions 13 and 14 of the protector 30 are not continuous along the entire front face but rather extend only over limited portions of that face. With this arrangement, the protector 30 incorporates recesses (31, 32, 33, 34) in the side portions 13, 14. In the version illustrated, the side portion 13 includes intermediate recess 31 and an upper recess 32 disposed at the top end 20 of the protector. The other side portion 14 includes an intermediate recess 33 which opposes the intermediate recess 31 and an upper recess 34 which opposes the recess 32.

With this arrangement the channel 19 of the protector is formed in first and second parts (35, 36) which are separated by the intermediate recesses 31, 33.

These recesses are designed to accommodate the racking beams 202 formed at the lower end of the CLS racking system 200 as best illustrated in FIG. 10.

To stiffen the upper end 20 of the protector 30, a stiffening member 37 is provided which acts as a tie at the upper end of the protector 30 and inhibits splaying of the mutually inclined portions 15, 16 of the front portion 12.

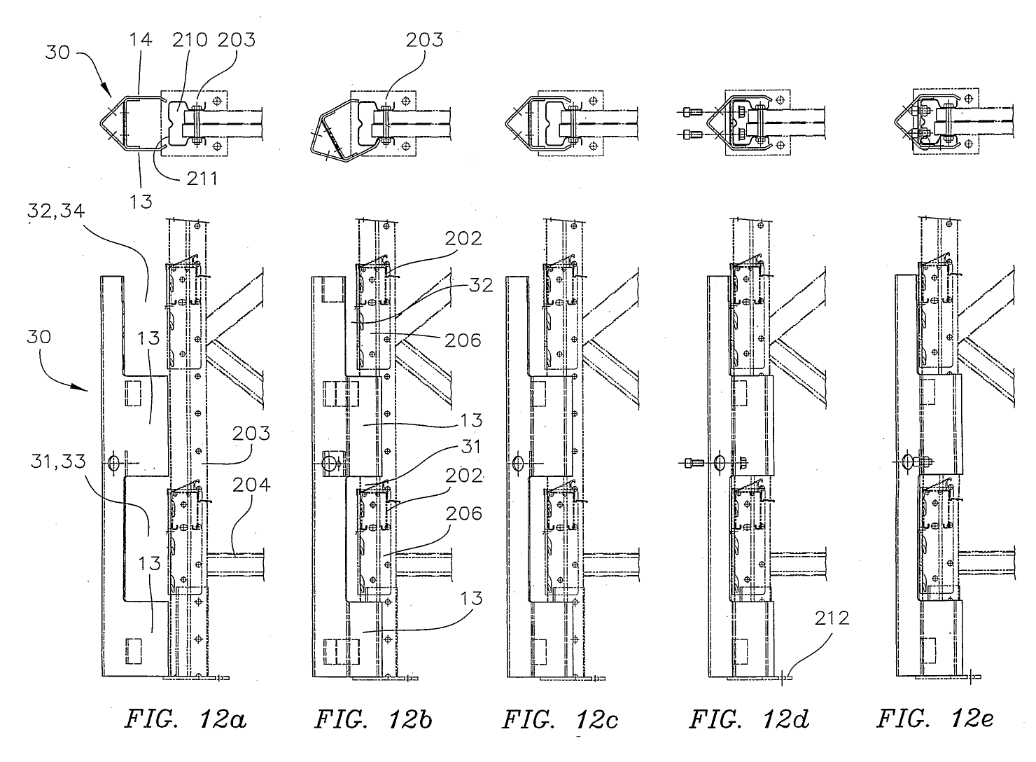

FIGS. 12a to 12e illustrate the sequence involved in mounting the protector 30 onto the upright 203 of the racking system 200.

The process of installation of the protector 30 is substantially the same as that described above in relationship to the protector 10. Specifically the protector is presented to the upright 203 at an angle and is then rotated so as to locate over the enlarged head region 210 of the upright 203. The protector 30 is then secured to the upright 203 by the retaining bolts 50 which extend through the intermediate clamping plate 25. This draws the bearing plates 23 and 24 into engagement with the front face 211 of the upright 203.

In contrast to the earlier embodiment however, the protector is presented directly onto the upright 203 and is not required to be moved laterally once it is in position around the upright 203. In this way, the side portions 13, 14 of the protector 30 are not required to move across the end connector plates 206 of the racking beams 202. Instead, the recesses 31, 32, 33 and 34 formed in the protector are sized so as to accommodate these connector plates 206. This arrangement has the benefit that it allows the protector 30 to be a closer fit to the upright 203 than it otherwise would if the channel 19 needed to cater for the additional width resulting from the combination of the upright 203 and the connector plates 206.

Also in the illustrated form, the protector 30 is sized to sit directly on the base plate 212 of the racking system 200, rather than leave the gap 91 as shown in the earlier embodiment.

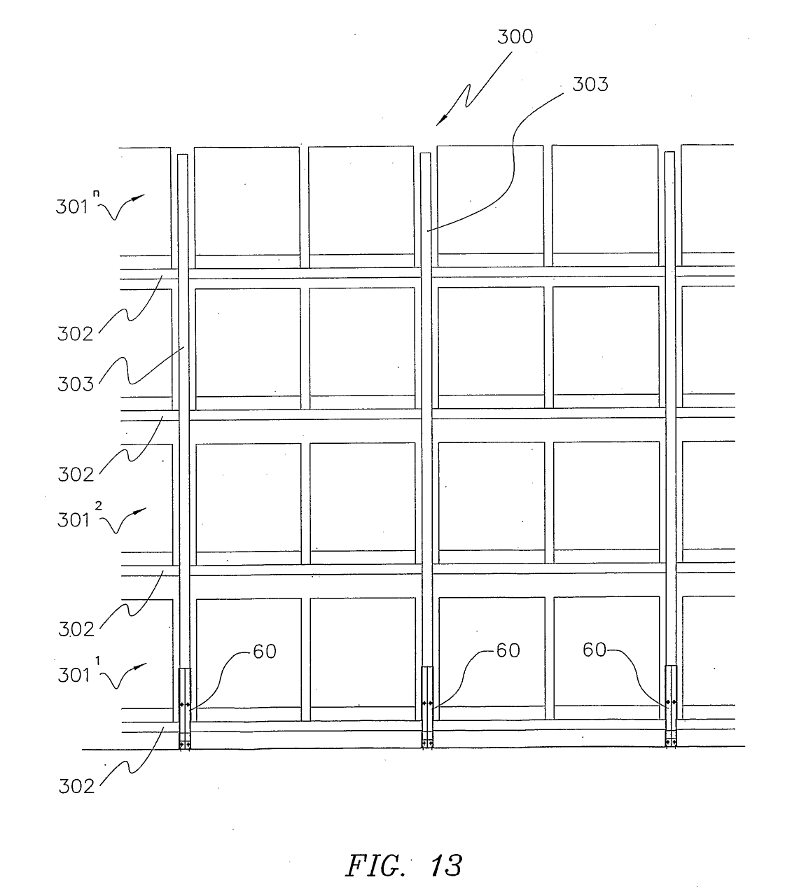

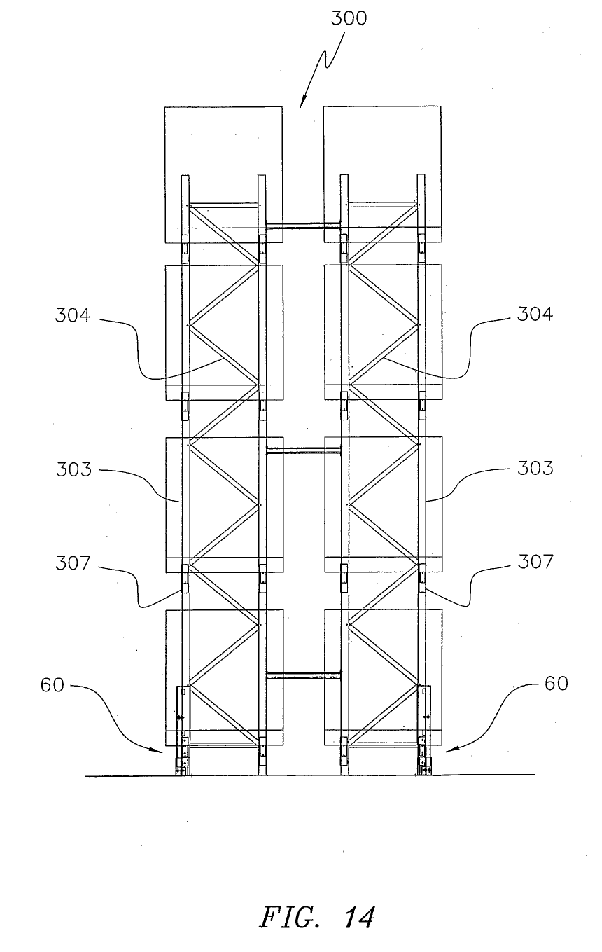

FIGS. 13 and 14 illustrate a low beam storage racking system 300. As in the earlier embodiments, the low beam racking system 300 includes multiple levels (301¹ . . . 301ⁿ) of metal racking beams 302 that are supported by vertical uprights 303. Again these uprights are made from a profiled steel section and metal bracing 304 is provided which extends between adjacent uprights 303. The metal racking beams 302 include connectors 307 at opposite ends which connect the beams 302 to the adjacent uprights 303. The characteristic feature of the low beam racking system 300 is that the bottom most racking beam 302 is spaced close to the ground.

Again, as in the earlier embodiments, protectors 60 are incorporated on the uprights 303 to protect against damage from handling equipment such as forklifts.

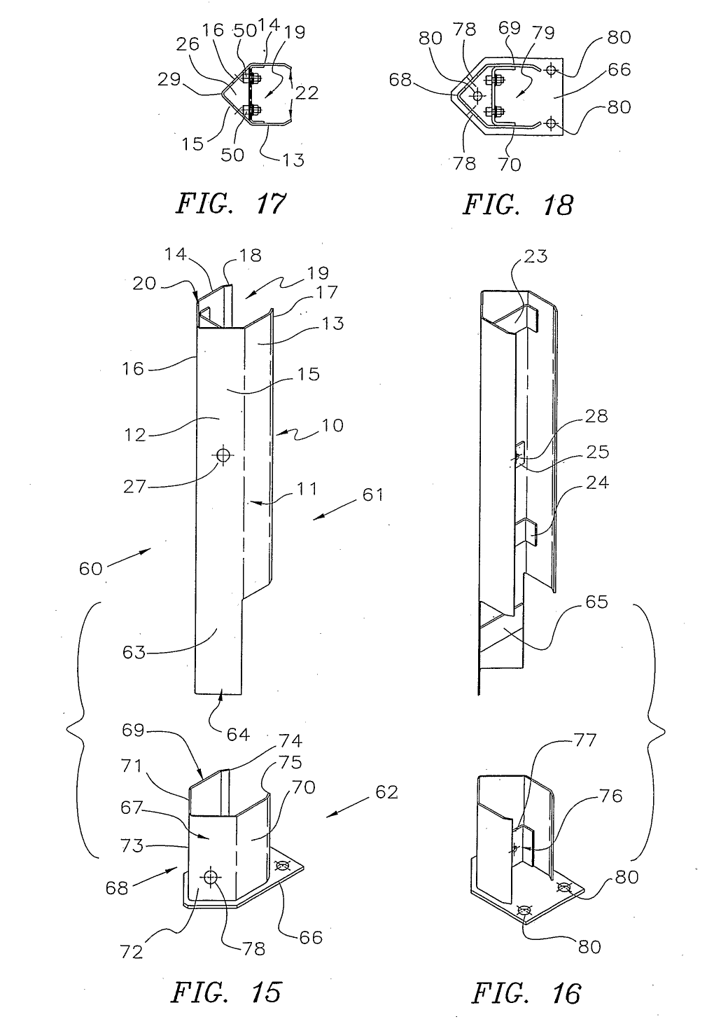

FIGS. 15 through to 18 illustrate the protector 60 for the low beam racking system 300.

As distinct from the other versions of the protector disclosed above, the low beam racking system protector 60 is formed in two parts; namely an upper part 61 and a base part 62.

The upper part 61 of the protector 60 includes many of the features of the protector 10 and for convenience, like features have been given like reference numerals.

Consistent with the protector 10, the upper part 61 includes a body 11 that is profiled to be generally channel shaped having a front portion 12 and opposing side portions 13 and 14. The front portion 12 is formed from the mutually inclined portions 15, 16 and the side portions 13 and 14 each include the inwardly turned lips 17, 18. The upper part 61 further includes the bearing members 23 and 24 and the clamping member 25 is disposed between these bearing members.

The main difference with the protector upper part 61 as compared to the protector 10 is that the upper part 61 includes a tail region 63 that is formed at the lower end 64 of the upper part 61. This tail region 63 is formed as a continuation of the front portion 12. The tail portion 63 also includes a stiffening member 65 which extends across the mutually inclined portions 15 and 16 to prevent splaying of those portions.

The base part 62 forms the base assembly of the low beam racking system 300 on which the upright 303 locates. The base part 62 includes a base plate 66 and a body portion 67 that extends upwardly from the base plate 66. The body portion 67 is typically formed from sheet metal and is profiled to be a generally channel shape similar to the body portion 11 of the upper part 61. However, the front portion 68 is slightly larger than the front portion 12 of that upper part 61 so that the body portion 67 can receive the tail portion 63 as will be described in more detail below. The body portion 67 also includes opposing side portions to define a channel 79 in the body portion 67. The front portion 68 is formed from mutually inclined portions 71, 72 that taper towards a ridge 73 and the side portions 69, 70 each include an inwardly turned lip 74, 75.

The base part 62 further includes an anchoring device 76 which is disposed within the body 67 which is arranged to receive at least one mechanical fastener to secure the base part 62 to the upright 303. The anchoring device 76 in the illustrated form is in the form of a channel shaped fixing plate 77 and a plurality of apertures 78 extend both through the front portion 68 and through the fixing plate 77.

The base plate 66 also includes apertures 80 to enable the base part 62 to be fixed to an underlying structure.

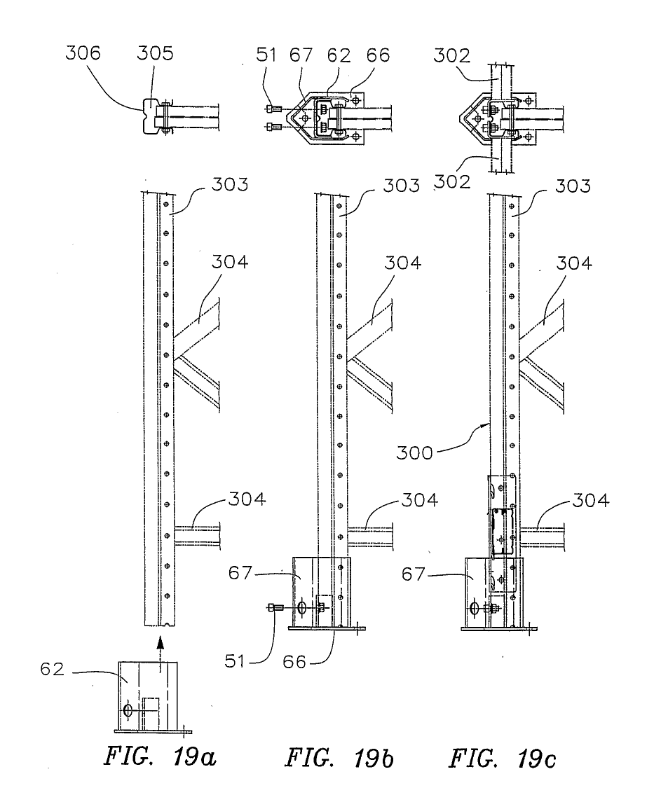

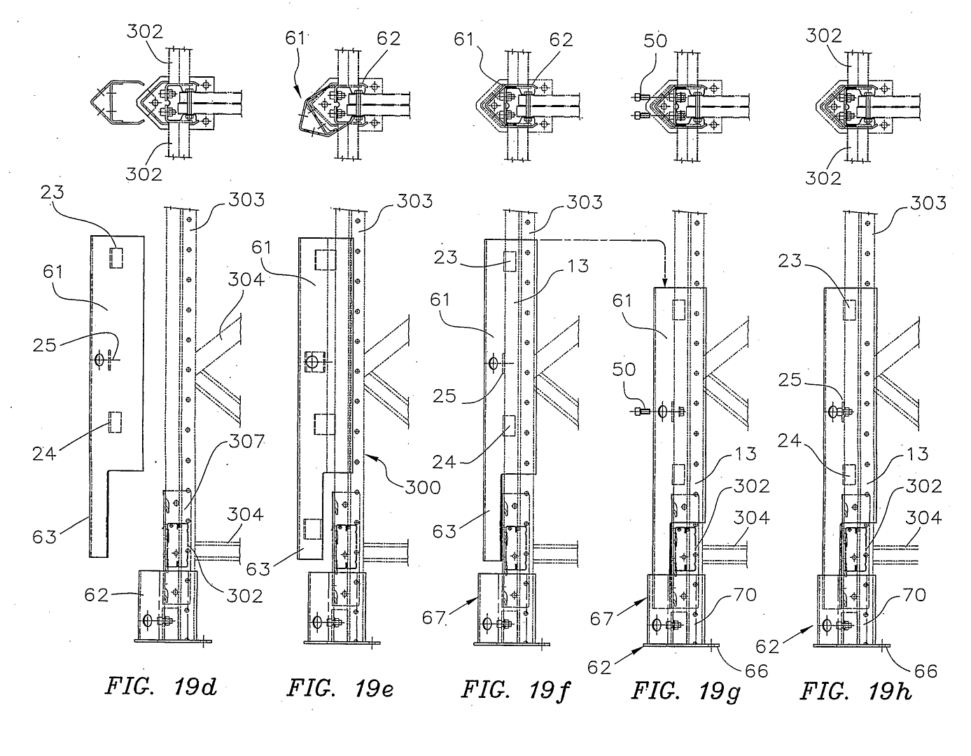

FIGS. 19a through to 19h illustrate the sequence involved in mounting the two part protector 60 onto the upright 303 of the low beam racking system 300.

To locate the base part 62 in position, the upright 303 is located within the channel 79 of the base part body 67. In the illustrated form, this is achieved by effectively dropping the upright 103 into the open top of the base part 62. As the body portion 67 of the base part 62 includes the constricted throat which is narrower than the enlarged head region 305 of the upright, the base part 62 could also be located at the lower end of the upright 303 by being manipulated into position through a rotating action as disclosed with respect to the earlier embodiments of the protector.

The base part 62 is secured to an underlying structure (not shown) by extending through the apertures 80 formed in the base plate 66. The base part 62 is secured to the upright 303 by the provision of bolts 51 that extend through the apertures 78 so that the fixing plate 77 is firmly attached to the front face 306 of the upright 303.

The upper part 61 of the protector is installed in a similar manner to that disclosed with respect to the protector 10. This assembly sequence is shown in FIGS. 19d to 19h.

In particular, the protector part 61 is presented at an angle to the upright 303 so that the constricted throat 22 of the protector part 61 is able to clear the enlarged head 305 of the upright. Once the part 61 is disposed around the upright 303, as best illustrated in 19f, it is then moved downwardly so that the tail region 63 locates within the channel 79 of the base part 62. As best seen in FIGS. 19g and 19h, the tail region 63 does not locate fully within the base part 62 and as such, the side portions 13 and 14 of the upper part 61 are spaced from the corresponding side portions 69 and 70 of the base part 62 to create opposing recesses which are operative to accommodate the lower most racking beams 302. The upper part 61 is then secured onto the upright by the fasteners 50 extending through the clamping member in a manner consistent with the earlier embodiments.

An advantage of the low beam racking protector 60 is that the lapped region between the parts 61 and 62 provides the maximum possible side coverage of the upright 303 in the vicinity of the low beam end connectors 307, while still preventing catch points at the lower end 64 of the upper part 61, by inserting the tail region 63 into the body portion 67 of the base part 62.

In the claims which follow and in the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

Variations and modifications may be made to the parts previously described without departing from the spirit or ambit of the invention.

1-40. (canceled)

41. A protector for a structural member comprising a channel shaped body formed from sheet metal having a front portion and opposite side portions that extend from the front portion to respective distal edges, the protector being locatable over the structural member so that at least a portion of the member is received within the channel, wherein at least one of the side portions includes an inwardly turned lip along its distal edge margin that defines a constricted throat of the channel.

42. The protector according to claim 41, wherein both side portions include an inwardly turned lip.

43. The protector according to claim 41, further comprising at least one bearing member that is connected to, or integrally formed with, the body and being disposed on an inner side of the front portion so as to be arranged to bear against the structural member.

44. A protector for a structural member comprising a body having a front portion and opposite side portions extending from at least one part of the front portion to define a channel, the protector being locatable over the structural member so that at least a portion of the structural member is received within the channel, wherein the protector further comprises at least one bearing member that is connected to, or integrally formed with, the body, and being disposed on an inner side of the front portion so as to be arranged to bear against the structural member.

45. The protector according to claim 44, further comprising a plurality of said bearing members which are disposed in spaced relationship from one another.

46. The protector according to claim 44, wherein the at least one bearing member is channel shaped and extends between the side portions and along at least part of each of those side portions.

47. The protector according to claim 44, wherein the at least one bearing member is spaced from at least part of the front portion of the protector body so as to form a gap therebetween.

48. The protector according to claim 44, further comprising at least one clamping member arranged to receive at least one mechanical fastener to secure the protector to the structural member.

49. The protector according to claim 48, wherein the clamping member is offset from the at least one bearing member in a direction towards the front portion, so that on securing the protector to the structural member, the clamping member is drawn into engagement with the structural member.

50. The protector according to claim 48, further comprising a plurality of said bearing members which are disposed in spaced relationship from one another and, wherein the clamping member is disposed between two of said bearing members.

51. The protector according to claim 44, wherein the body is formed from sheet metal.

52. The protector according to claim 41, wherein the front portion is formed from mutually inclined portions that taper towards a ridge that forms a leading edge of the protector.

53. The protector according to claim 41, wherein the side portions each extend from one end of the protector to the other end so that the channel is continuous along the length of the protector.

54. The protector according to claim 41, wherein at least one of the side portions extends along a part of the front portion to form a recess in said protector, said recess being arranged to accommodate a beam which connects to, and extends transversely from, the structural member.

55. The protector according to claim 54, wherein the channel is formed in a plurality of sections that are separated by opposing said recesses formed along respective ones of the side portions.

56. The protector according to claim 54, wherein a said recess is disposed adjacent at least one end of the body.

57. The protector according to claim 41, wherein one end of said body is connected to a base plate on which the structural member is arranged to locate.

58. The protector according to claim 57, wherein the base plate incorporates at least one aperture to receive a mechanical fastener to fix the base plate to an underlying structure.

59. A protector for a structural member and comprising first and second parts, each part having a body extending between opposite ends and having a front portion and opposite side portions that extend from at least one part of the front portion to define a channel, the parts being arranged so that at least a portion of the structural member is able to be received in the respective channels, wherein the first and second parts are arranged in use to be disposed in end to end and overlapping relationship on the structural member.

60. The protector according to claim 59, wherein the side portions of the first part terminate in board of one end of that part to form a tail region that extends to said one end and is arranged to lap with the second part.

61. The protector according to claim 60, wherein when the tail region of the first part is lapped with the second part, at least one of the side portions of the first part is spaced from the corresponding side portion of the second part to form a recess arranged to receive a beam that connects to, and extends transversely from, said structural member.

62. The protector according to claim 60, wherein the tail region includes at least one stiffening member.

63. The protector according to claim 59, wherein a second end of one of the first and second parts is connected to a base plate on which the structural member is arranged to locate.

64. The protector according to claim 63, wherein the base plate includes at least one aperture to receive a mechanical fastener to fix the base plate to an underlying structure.

65. The protector according to claim 58, wherein that part of the protector that has a base plate connected thereto further comprising an anchoring device arranged to receive at least one mechanical fastener to secure that part of the protector to the structural member.

66. The protector according to claim 65, wherein the anchoring device comprises a fixing plate disposed within the channel and one or more aligned apertures that extend both through the front portion and the fixing plate of that part.

67. The protector according to claim 59, wherein at least one of the side portions of at least one of the first and second parts of the protector include at least one inwardly turned lip that defines a constricted throat of the channel of that part.

68. The protector according to claim 59, wherein the first part further comprises at least one bearing member disposed on an inner side of the front portion and arranged to bear against the structural member.

69. The protector according to claim 68, further comprising a plurality of said bearing members which are disposed in spaced relationship from one another.

70. The protector according to claim 68, further comprising at least one clamping member operative to receive at least one fastener to secure the first part of the protector to the structural member.

71. The protector according to claim 70, wherein the or each bearing member and clamping member, is spaced from the front portion of the part of the protector on which the members are disposed so as to form a gap therebetween.

72. The protector according to claim 41, wherein the body includes at least one aperture arranged to allow access for at least one mechanical fastener to secure the protector to the structural member.

73. An assembly for use in the support structure of a storage racking system, the assembly comprising an elongated structural member; and a protector according to claim 41, wherein at least a portion of the structural member is receivable in the channel of the protector.

74. The assembly according to claim 73, wherein the structural member is a profiled section having an enlarged head and a narrower rear region.

75. The assembly according to claim 74, wherein the distance between the side portions at the constricted throat of the protector is less than the width of the enlarged head region.

76. The assembly according to claim 75, wherein the or each inwardly turned lip of the constricted throat of the channel locates in or over the narrower rear region of the structural member.

77. The assembly according to claim 76, wherein the protector is substantially rigid and the assembly is arranged so that the protector is installed by presenting the protector at an angle to the structural member and then rotating the protector into its installed orientation where the or each inwardly turned lip of the constricted throat of the channel locates in or over the narrower rear region of the structural member.

78. The assembly according to claim 73, wherein the protector is formed from sheet metal.

79. An assembly for use in the support structure of a storage racking system, the assembly comprising an elongated structural member; and a protector according to claim 44, wherein the bearing member is arranged to bear against a front face of the structural member.

80. A storage racking system incorporating a support structure assembly according to claim 73.

81. A storage racking system incorporating a support structure assembly according to claim 79.
